(19) United States
(12) Patent Application Publication
(10) Pub. No.: US 2007/0174914 A1
(43) Pub. Date: Jul. 26, 2007

(54) Data coordination method, computer product, and information processing terminal

(75) Inventors: Toshimitsu Kumagai, Kawasaki (JP); Hiroshi Kaga, Kawasaki (JP); Tsutomu Hoshi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/394,100

(22) Filed: Mar. 31, 2006

(30) Foreign Application Priority Data
Dec. 13, 2005 (JP) 2005-359475

(51) Int. Cl. G06F 12/14

(52) U.S. Cl. 726/24

(57) ABSTRACT

Data coordination is performed between a source application program and a destination application program in an information processing terminal. A virus pattern file and a data string pattern file are prepared in advance. A virus detecting program is used to detect a virus based on the virus pattern file and to look for a specific data string based on the data string pattern file in a data created by the source application program before storing the data. If the specific data string is found in the data, that data string and path of the data is informed to the destination application program.

### BACKGROUND OF THE INVENTION

1. Field of the Invention

The present invention relates to a technology for coordinating data between various application programs that handle storage of data in a storage unit and a virus detection program that detects a virus contained in the data based on a virus pattern file describing characteristics of viruses.

2. Description of the Related Art

Mobile phones are becoming multifunctional. Most mobile phones now have an e-mail function, a web page browsing function, a music reproducing function, and a photograph function.

In a mobile phone, data files are generally stored in a storage device within the mobile phone. Along with the increase of the functions of mobile phones, types and number of the data files that need to be stored have increased. As a result, there is a need to efficiently group and manage the data files. Various techniques have been proposed to achieve this. One approach includes adding unique classification information to data files. Another approach includes using a data file name to facilitate classification.

For example, Japanese Patent Application Laid-Open (JP-A) No. 2003-134454 discloses a technique that appends a date on which image data was photographed to be included in a data file indicative of the image data. On the contrary, JP-A No. 2001-34632 discloses a technique that appends the name of the place where image data was photographed to be included in a data file indicative of the image data.

Thus, the techniques disclosed in JP-A Nos. 2003-134454 and 2001-34632 include appending unique information to data files. However, some application programs (AP) cannot handle such data files that are appended with additional information. In other words, there is a limitation on where the conventional techniques can be employed.

Many APs (for example, an e-mail AP, a camera AP, and a web browser AP) are installed in a multifunctional mobile phone, and generally, file formats that are handled by these APs are not the same. Accordingly, although some APs can handle the data files that are appended with additional information, others cannot.

For example, when a user of a mobile phone wishes to rearrange data files stored in a predetermined directory by the camera AP, it is necessary to shift the data file by creating a new directory. However, such an operation is troublesome, and is not convenient for the user.

Data files such as e-mail data files, music files, web page data files, image data files that are handled by mobile phones are in conformity with a standardized format. That is, these data files already include information such as the date when the file is created.

One approach could be to create a search program that can extract information, such as date, from these data files, and install the program to mobile phones. However, creation of a new search program increases the costs.

Therefore, there is a need of a technique that can easily and at low costs coordinate data files among various APs. This issue is not particularly limited to the mobile phones, and applies likewise to information processing terminals such as a personal digital assistant (PDA).

### SUMMARY OF THE INVENTION

It is an object of the present invention to at least solve the problems in the conventional technology.

According to an aspect of the present invention, a data coordination method of coordinating data between a source application program and a destination application program in an information processing terminal, the information processing terminal including a data storage unit configured to store therein data, a virus pattern file describing characteristics of a computer virus, and a data string pattern file describing a detecting data string; and an applications storage unit that stores therein a plurality of application programs each capable of creating data and storing the data in the data storage unit, and a virus detection program configured to detect a virus contained in the data created by any one of the application programs based on the virus pattern file before storing the data in the data storage unit, the application programs including a source application program that creates a specific data and a destination application program that makes use of the specific data, includes executing the virus detection program whereby the virus detection program looks for a data string in the specific data based on the detecting data string in the data string pattern file in the data storage unit and extracts the data string if such a data string is present in the specific data; and notifying the data string extracted by the virus detection program at the executing and path information that specifies path of the specific data as data coordination information to the destination application program.

According to another aspect of the present invention, an information processing terminal includes a data storage unit configured to store therein data, a virus pattern file describing characteristics of a computer virus, and a data string pattern file describing a detecting data string; an applications storage unit that stores therein a plurality of application programs each capable of creating data and storing the data in the data storage unit, and a virus detection program configured to detect a virus contained in the data created by any one of the application programs based on the virus pattern file before storing the data in the data storage unit, the application programs including a source application program that creates a specific data and a destination application program that makes use of the specific data; an executing unit that executes the virus detection program whereby the virus detection program looks for a data string in the specific data based on the detecting data string in the data string pattern file in the data storage unit and extracts the data string if such a data string is present in the specific data; and a notifying unit that notifies the data string extracted by the virus detection program and path information that specifies path of the specific data as data coordination information to the destination application program.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 depicts an outline of a data coordination method according to an embodiment of the present invention;

FIG. 2 is a block diagram of an information processing terminal according to the embodiment;

FIG. 3 depicts functioning of a data string pattern file;

FIG. 4 is one example of contents of the data string pattern file;

FIG. 5 is a flowchart of a process procedure performed by a virus detection processor shown in FIG. 2;

FIG. 6 is a flowchart of a process procedure performed by a detection engine shown in FIG. 2;

FIG. 7 is a flowchart of a data file associating process procedure in a scheduler AP;

FIG. 8 is a flowchart of a display process procedure in the scheduler AP;

FIG. 9 is one example of a user interface;

FIG. 10 is one example of a data display;

FIGS. 11 to 13 are schematics to explain a conventional technique.

### DETAILED DESCRIPTION OF THE PREFERRED EMBODIMENTS

Exemplary embodiments of the present invention will be explained in detail with reference to the accompanying drawings. In the embodiments, a data coordination method is applied to a mobile phone installed with two APs of a camera AP and a schedule management AP (hereinafter, “scheduler AP”); however, the invention is not limited to this.

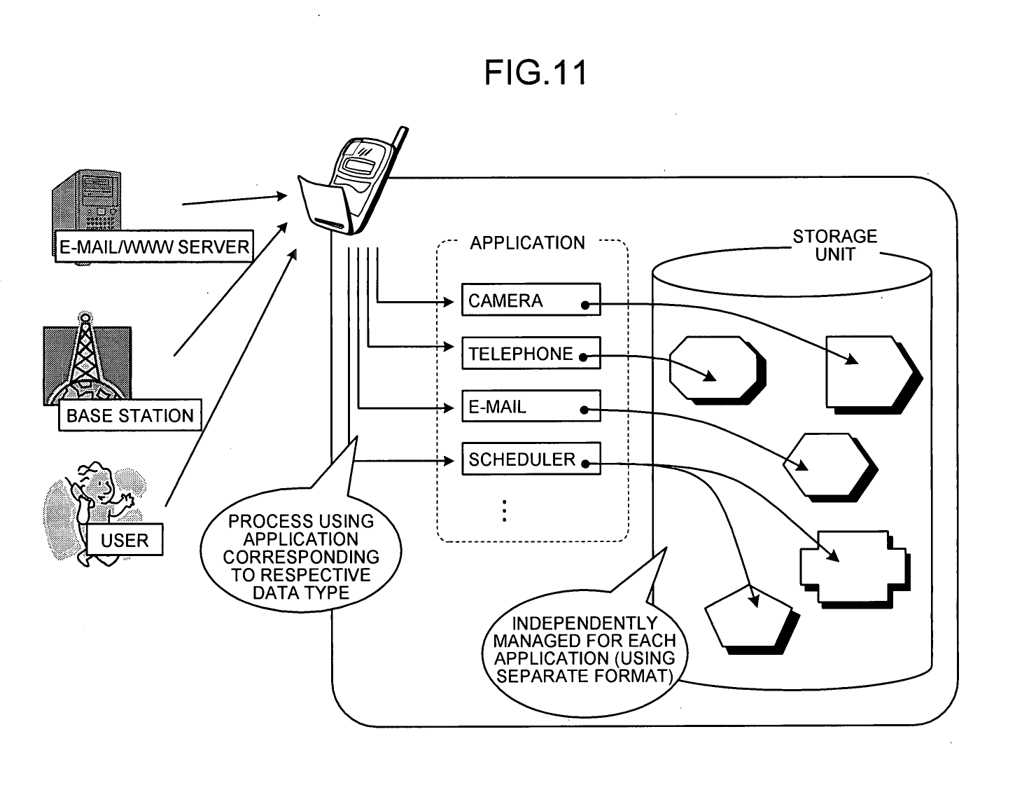

Outlines of conventional techniques and problems thereof are explained with reference to FIGS. 11 to 13.

As shown in FIG. 11, a conventional mobile phone has a plurality of applications (AP) installed in it and the mobile phone includes a storage unit for storing data files handled by each of the APs. The APs include, for example, a camera AP, a telephone AP, an e-mail AP, a scheduler AP. Each AP creates a data file having a unique format. Data files have been represented in the figure by unique-shaped blocks to shown that the data files have unique formats. Therefore, conventionally, a certain AP cannot read data files of other APs.

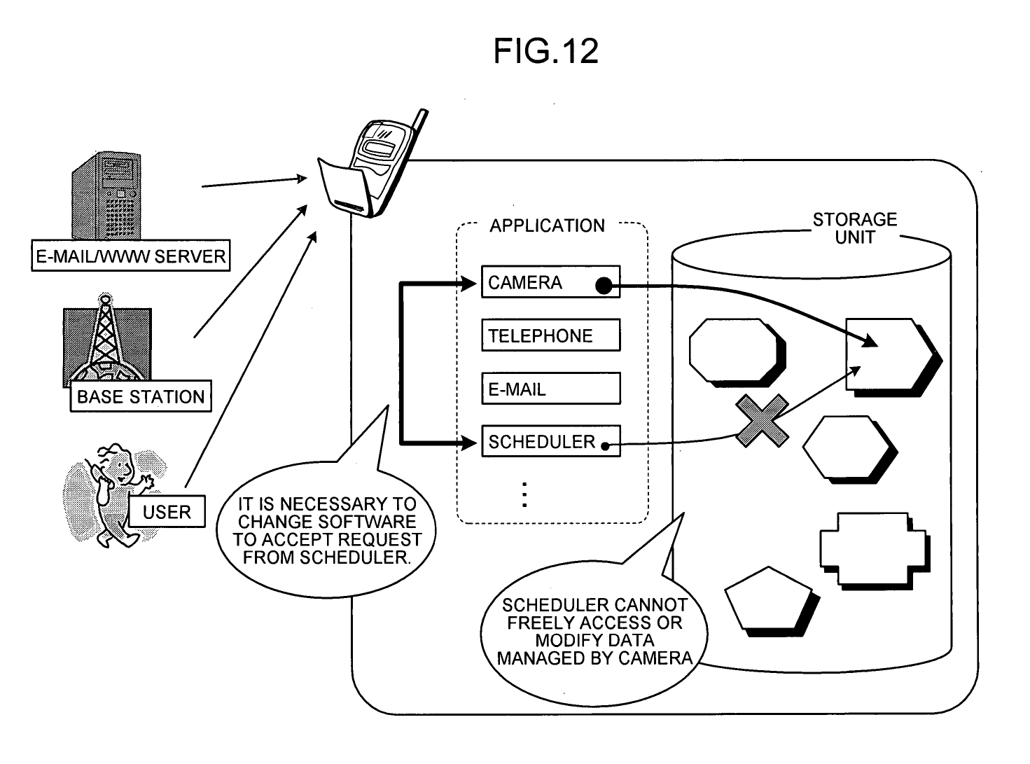

In other words, as shown in FIG. 12, the scheduler AP cannot freely access a data file of the camera AP. Therefore, in order for the scheduler AP to handle the data file stored by the camera AP, it is necessary to modify the software, such as making the data format common.

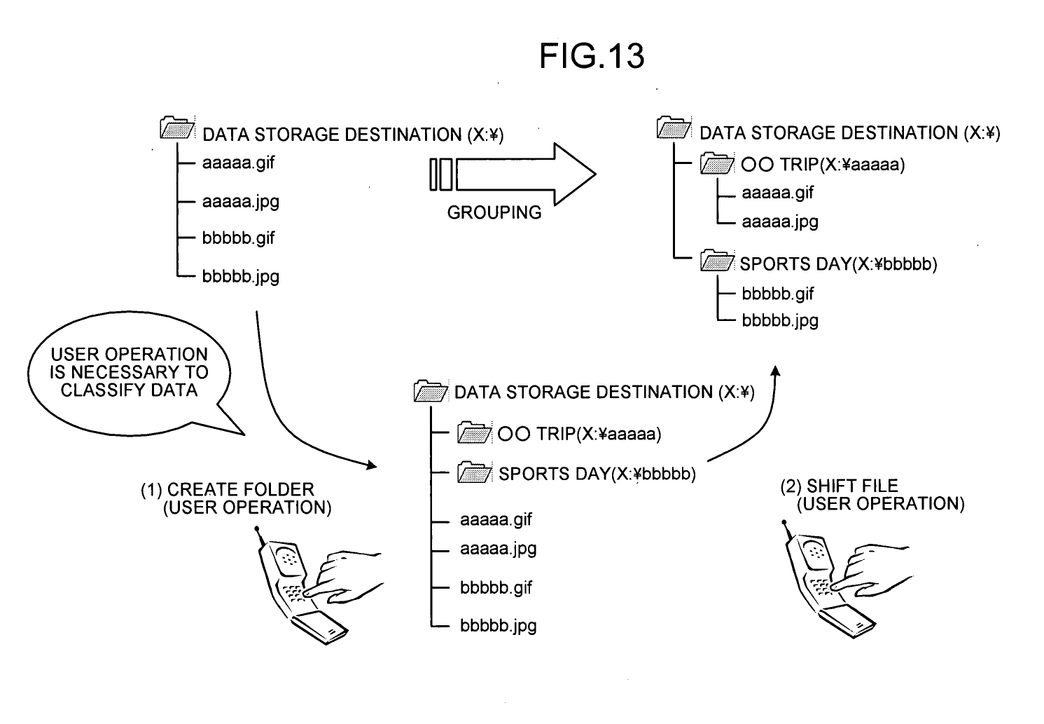

As shown in FIG. 13, therefore, if a mobile phone user wishes to rearrange a data file (“˜.gif” file or “˜.jpg”) stored in a predetermined directory by the camera AP, the user needs to create a new directory (folder) (see (1)), and shift the data file to the created folder (see (2)). However, such an operation is troublesome, and is not convenient for the user.

According to the present invention, therefore, instead of adding unique information for each AP to a data file, information initially included in a data file is extracted, and coordination of data between APs is performed by using the extracted information. Thus, there is no need to modify the APs. The information initially included in a data file refers to information such as a date included in a format, to which the respective data files such as the e-mail data file, the music file, the web page data file, and the image data file conform, that is, in a standardized format.

An existing virus detection program is used to extract the information initially included in the data file, and the extracted information is passed to an AP. Because an existing program is used, there is no need to create a new program, so that costs can be reduced.

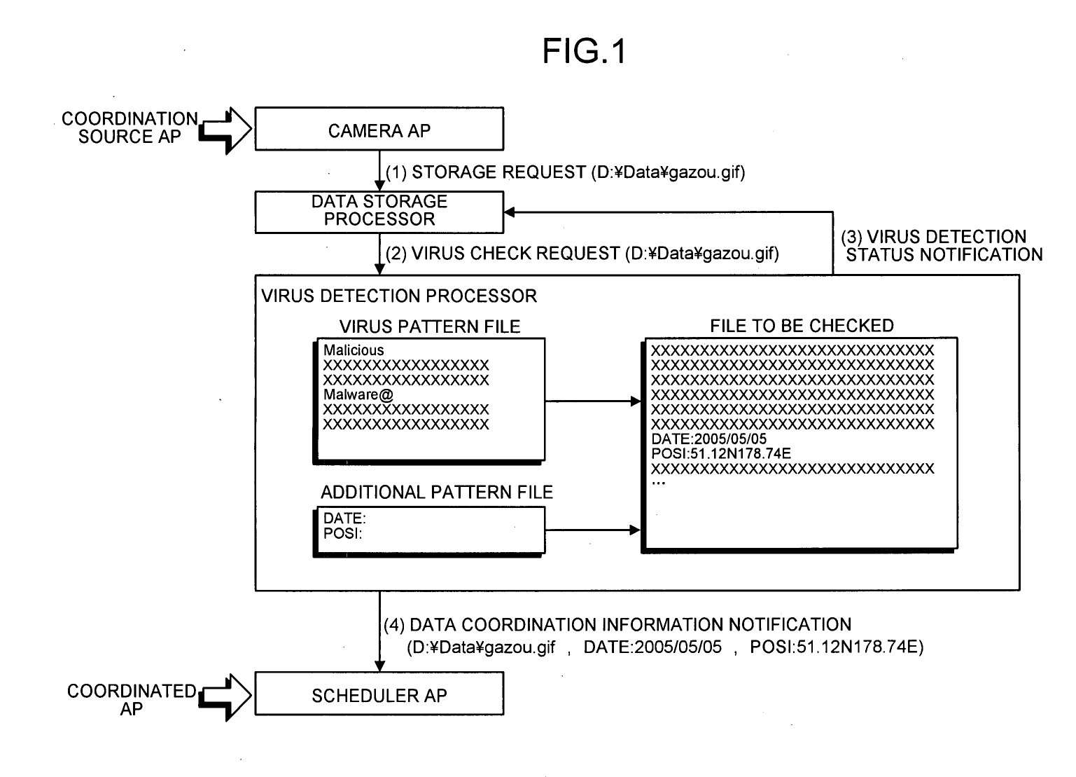

FIG. 1 depicts an outline of a data coordination method according to an embodiment of the present invention. In FIG. 1, a camera AP is a coordination source AP that stores data in the storage unit, and a scheduler AP is a coordination destination AP that uses the data stored in the storage unit by the coordination source AP.

When the camera AP requests a data storage processor to store a file “D:\Data\gazou.gif” (see (1)), the data storage processor requests a virus detection processor to perform virus check on the file “D:\Data\gazou.gif” (see (2)). Procedures (1) and (2) are performed to confirm that a virus is not included in the file.

The virus detection processor checks whether a virus is included in the file by using a virus pattern file. An additional pattern file is prepared in advance, in addition to the virus pattern file, and the additional pattern file is used to extract information required for the data coordination from the file.

Keywords, such as “DATE:”, which is a keyword expressing the storage position of date information, and “POSI:”, which is a keyword expressing the storage position of position information, can be included in the additional pattern file. Assuming that “DATE:” and “POSI:” are included in the additional pattern file, the virus detection processor extracts date (2005/05/05) and position (51.12N178.74E) from the file, and notifies the scheduler AP of data coordination information. The data coordination information includes the extracted information and access information required for accessing the data file (D:\Data\gazou.gif, that is, a path name and a file name) (see (4)).

When a virus is detected, the virus detection processor notifies the fact that a virus has been detected to the data storage processor (see (3)) and does not perform the procedure (4). When a virus is not detected, the virus detection processor notifies the data storage processor that no virus is detected.

The scheduler AP receives the data coordination information, accesses the file (D:\Data\gazou.gif) based on the access information, and executes data coordination processing and data display processing based on the date information (2005/05/05) and the position information (51.12N178.74E) included in the data coordination information.

Thus, the “additional pattern file” is newly added as the pattern file, the virus detection processor is made to extract information based on the additional pattern file from the file, and the extracted information is passed to the coordination destination AP. Therefore, the data coordination from the coordination source AP to the coordination destination AP can be realized only by modifying the virus detection processor. As a result, the data file can be coordinated among the respective APs without adding unique information to the data file. The program creation costs can be also reduced by using the existing virus detection processor.

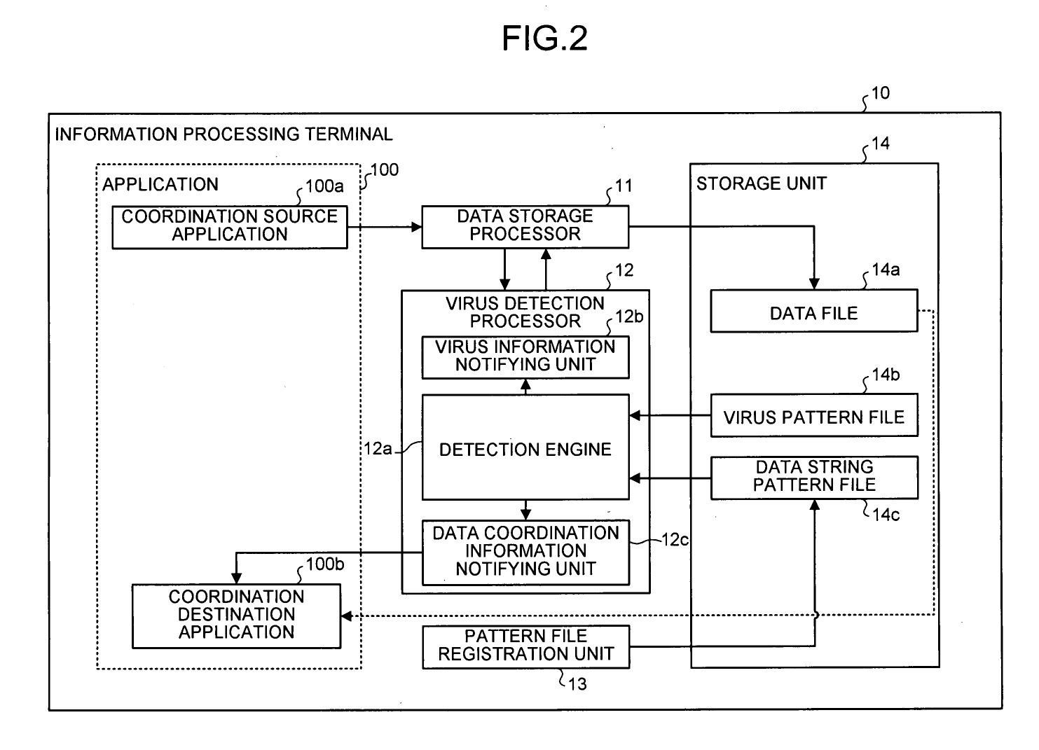

A configuration of the information processing terminal, to which the data coordination method according to the present invention is applied, is explained with reference to FIG. 2. FIG. 2 is a block diagram of the configuration of an information processing terminal 10 according to the embodiment. A mobile phone, a personal digital assistant (PDA) terminal, or a personal computer (PC) can be used as the information processing terminal.

As shown in FIG. 2, the information processing terminal 10 includes a data storage processor 11, a virus detection processor 12, a pattern file registration unit 13, a storage unit 14, and an application 100. The virus detection processor 12 includes a detection engine 12a, a virus information notifying unit 12b, and a data coordination information notifying unit 12c. The storage unit 14 stores a data file 14a, a virus pattern file 14b, and a data string pattern file 14c. The application 100 includes at least a coordination source application 100a and a coordination destination application 10b.

The data storage processor 11 receives a request for storing a data file from the coordination source application 10a, and requests the virus detection processor 12 to check for a virus in the data file. The data storage processor 11 stores a data file that does not contain a virus in the storage unit 14.

The virus detection processor 12 checks whether the data file contains a virus by using the virus pattern file 14b, and detects a data string for data coordination by using the date string pattern file 14c.

In the virus detection processor 12, the detection engine 12a actually checks whether the file includes a virus or a specific data string based on the virus pattern file 14b and the data string pattern file 14c. Any ordinary detection engine can be used to detect a virus.

The virus information notifying unit 12b notifies the data storage processor 11 when the detection engine 12a detects a virus in the file. When a virus is detected, the data storage processor 11 does not store the data file in the storage unit 14. Thus, a corrupt file is prevented from being stored.

When the specific data string is detected, the data coordination information notifying unit 12c notifies the coordination destination application 100b that the data string is detected and also notifies a path name and a file name of the data file as data coordination information to the coordination destination application 100b.

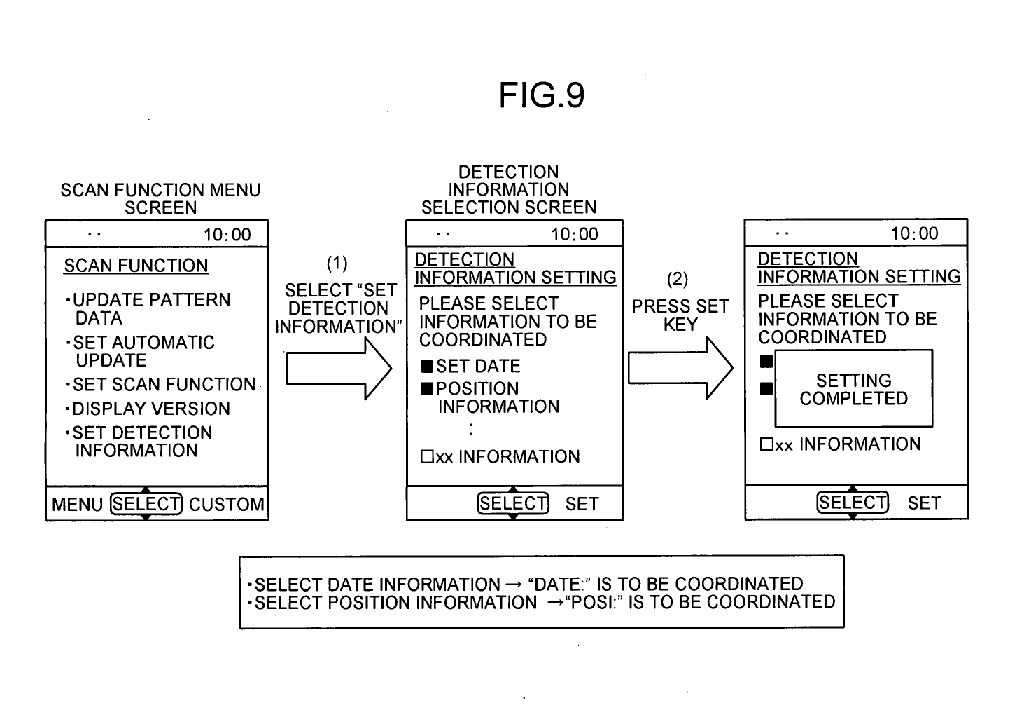

The pattern file registration unit 13 is used to register the data string pattern file 14c in the storage unit 14. The pattern file registration unit 13 includes a display unit (not shown) and an inputting unit (not shown) with which an operator creates the data string pattern file 14c. Details of a human-machine interface will be explained later with reference to FIG. 9.

The storage unit 14 can be a non-volatile random access memory (RAM), and stores therein the data file 14a, the virus pattern file 14b, and the data string pattern file 14c. The data file 14a can be an image file or a character file. The data file 14a is prepared by an application in the application 100.

The virus pattern file 14b contains data strings specific to computer viruses. When a new type of computer virus is discovered, a data string corresponding to the new virus is added into the virus pattern file 14b.

The data string pattern file 14c includes information used for detecting date strings such as a date and a position used for coordinating data among the applications in the application 100.

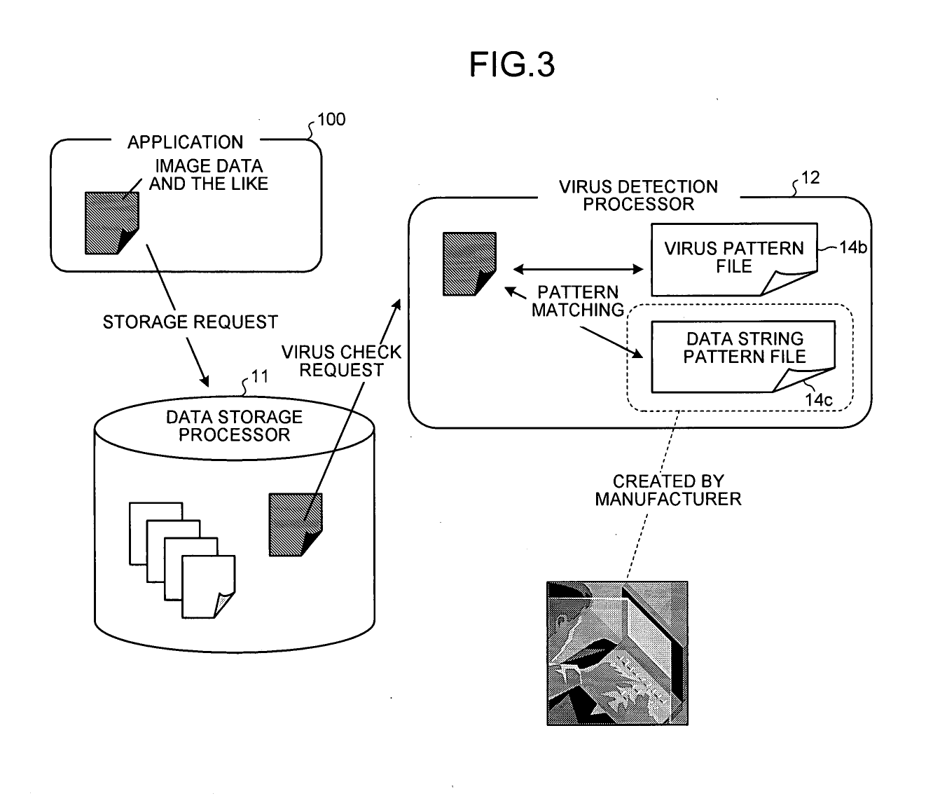

FIG. 3 depicts functioning of the data string pattern file 14c. As shown in FIG. 3, when the application 100 sends a storage request to requests the data storage processor 11 to store a data file, the date storage processor 11 transmits a virus check request to the virus detection processor 12.

The virus detection processor 12 then executes pattern matching using the virus pattern file 14b and the data string pattern file 14c with respect to the data file. As shown in FIG. 3, the data string pattern file 14c is prepared separately from the virus pattern file 14b.

Therefore, manufacturers of the information processing terminal 10 or the application 100 can easily create the data string pattern file 14c appropriate to data coordination between the respective applications. That is, the respective manufacturers can freely customize the information used for the data coordination.

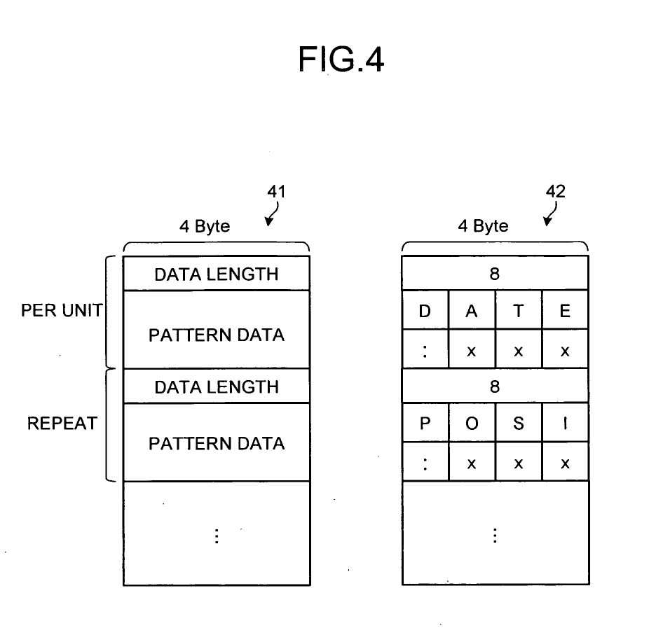

FIG. 4 is an example of contents of the data string pattern file 14c. Reference numeral 41 denotes an example of a file format of the data string pattern file 14c, and 42 denotes an example of setting data according to the file format 41.

In the file format 41, a set of data length and pattern data are repeated. In this manner, the data string pattern file 14c includes many data strings.

In the example of setting data 42, a first set of information has a data length of 8 bytes and a data string of “DATE:xxx”, a second set of information has a data length of 8 bytes and a data string of “POSI:xxx”. Since the data such as “DATE:” indicating the storage position of the date information or “POSI:” indicating the storage position of the position information are written in the data string pattern file 14c, the date information and the position information can be obtained from the data file to be detected for any virus.

It is obvious that the data length can be other than 8 bytes. Moreover, all the data lengths need not be the same.

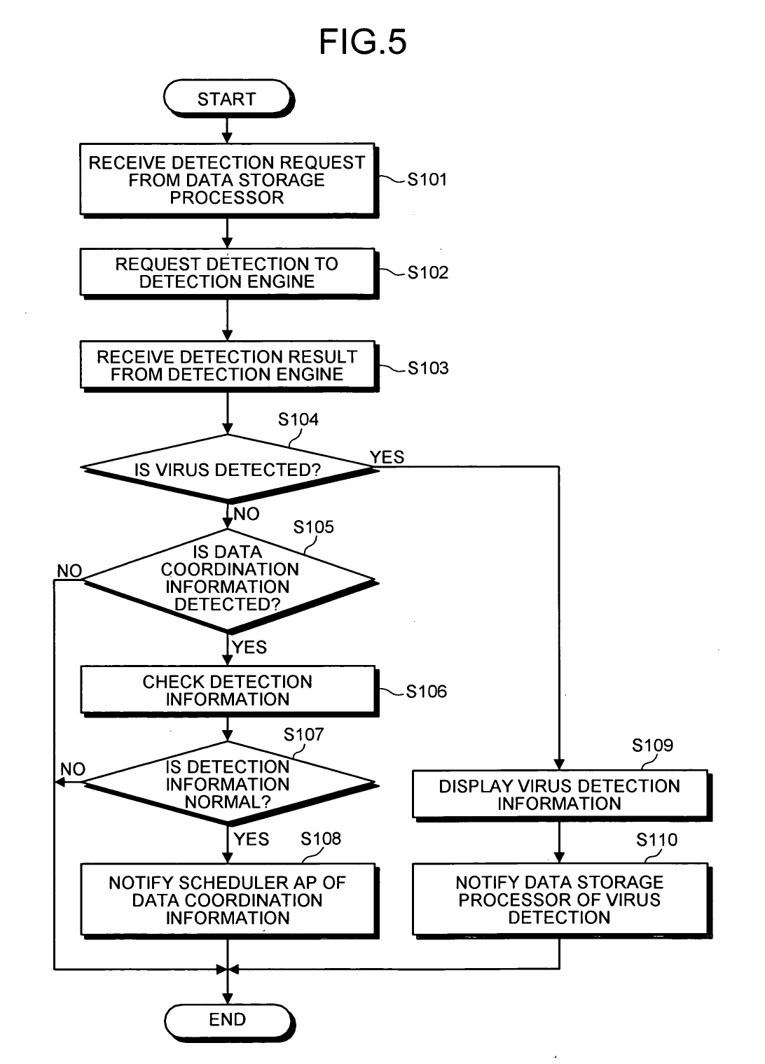

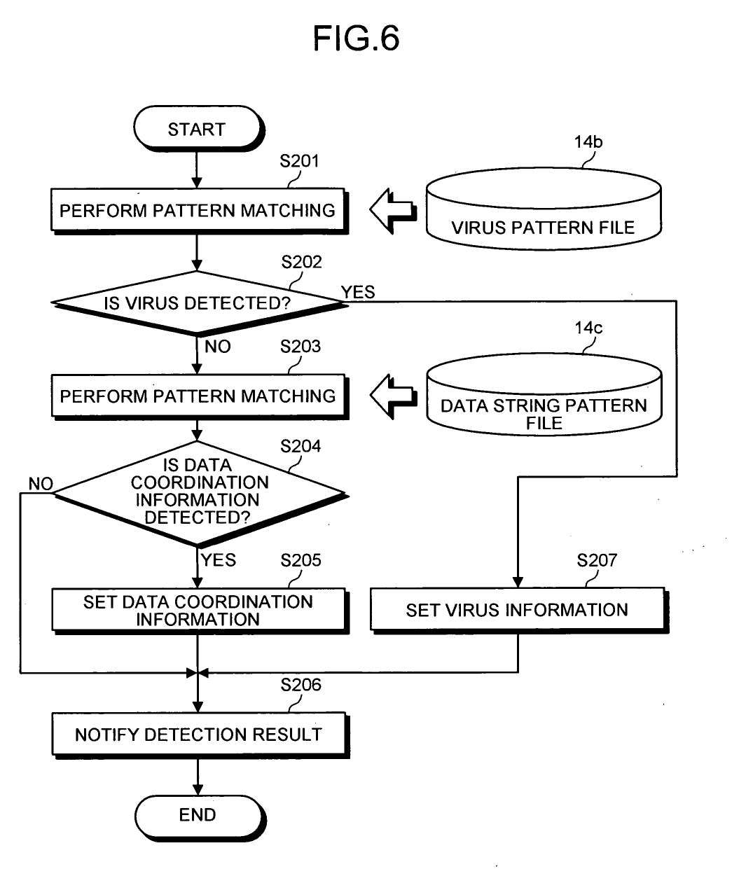

A process procedure performed by the virus detection processor 12 shown in FIG. 2 is explained with reference to FIG. 5. Upon receiving a detection request from the data storage processor 11 (step S101), the virus detection processor 12 makes a detection request to the detection engine 12a (step S102). The detail of a process procedure performed by the detection engine 12a is explained later with reference to FIG. 6.

When a virus is detected (step S104, Yes), the virus detection processor 12 displays the virus detection information on a display unit (not shown) (step S109). Subsequently, the virus information notifying unit 12b notifies the data storage processor 11 of detection of the virus (step S110), and the process is terminated.

On the other hand, when a virus is not detected (step S104, No), the virus detection processor 12 determines whether the data coordination information has been detected (step S105). When the data coordination information has been detected (step S105, Yes), the virus detection processor 12 checks the detection information (for example, checks whether the detected date is a possible date) (step S106).

When the detection result of the detection information is normal (step S107, Yes), the data coordination information notifying unit 12c notifies to the coordination destination application 100b (for example, the scheduler AP) of the data coordination information, and the process ends. When it is determined that there is no data coordination information at step S105 (step S105, No), or when the detection result of the detection information is abnormal at step S107 (step S107, No), the virus detection processor 12 terminates the process without executing the subsequent process procedure.

The process procedure performed by the detection engine 12a is explained with reference to FIG. 6. The detection engine 12a executes pattern matching using the virus pattern file 14b (step S201). When a virus is detected (step S202, Yes), the detection engine 12a sets virus information (step S207), and notifies the virus detection processor 12 of the detection result (step S206), to finish the processing.

When a virus is not detected at step S202 (step S202, No), the detection engine 12a executes pattern matching using the data string pattern file 14c (step S203). When the data coordination information (for example, “DATE:” and “POSI:” shown in FIG. 4) is detected, the detection engine 12a sets the data coordination information (step S205), and notifies the virus detection processor 12 of the detection result (step S206), to finish the processing.

When it is determined that the data coordination information is not detected at step S204 (step S204, No), the detection engine 12a notifies the virus detection processor 12 of the detection result (that the data coordination information is not detected), with none of the virus information and the data coordination information being set (step S206), and finishes the processing.

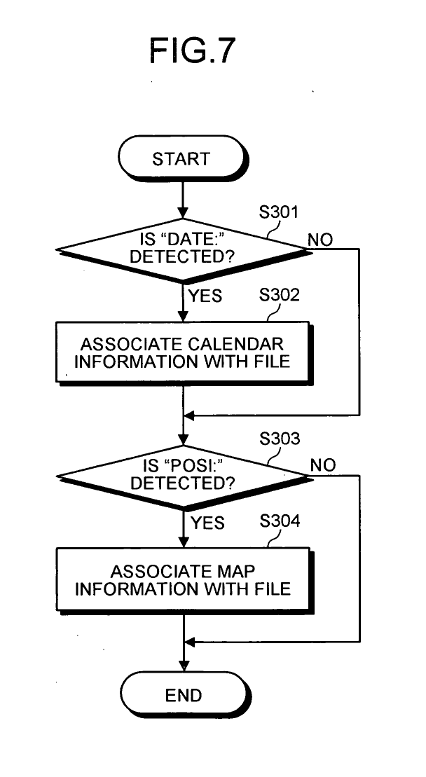

A state in which the coordination destination application 100b having received the data coordination information from the data coordination information notifying unit 12c in the virus detection processor 12 coordinates data, using the data coordination information, is explained with reference to FIGS. 7 to 11. FIGS. 7 to 11 are examples where the coordination destination application 100b is a scheduler AP that manages a schedule by using calendar information or map information.

FIG. 7 is a flowchart of a data file associating process procedure performed by the scheduler AP. The scheduler AP having received the data coordination information from the data coordination information notifying unit 12c determines whether “DATE:” has been detected (step S301). When it is determined that “DATE:” has been detected (step S301, Yes), the scheduler AP associates the calendar information with the file (data file for which virus check is performed) (step S302). When it is determined that the “DATE:” has not been detected at step S301 (step S301, No), the scheduler AP executes the process procedure at step S303, without executing the process procedure at step S302.

The scheduler AP then determines whether “POSI:” has been detected (step S303). When it is determined that “POSI:” has been detected (step S303, Yes), the scheduler AP associates the map information with the file (data file for which virus check is performed) (step S304), and the process ends there. When it is determined that “POSI:” has not been detected at step S303 (step S303, No), the process ends without executing the process procedure at step S304.

The “DATE:” and the “POSI:” shown in FIG. 7 are an example of the keyword for the data coordination information, and when other keywords are set in the data string pattern file 14c, detection determination based on the keyword set in the data string pattern file 14c is performed.

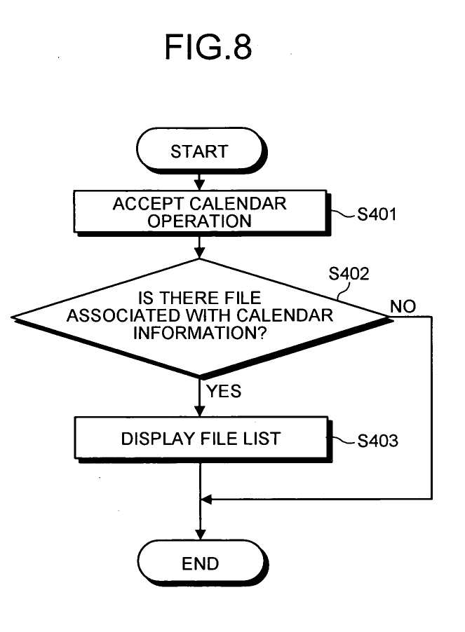

A display process procedure performed by the scheduler AP is explained with reference to FIG. 8. When a user performs a calendar operation (step S401), the scheduler AP determines whether there is a file (data file) associated with the calendar information (step S402). When having determined that there is the file associated with the calendar information (step S402, Yes), the scheduler AP displays in a list, the relevant file together with the calendar (step S403), and finishes the processing.

When having determined that there is no file associated with the calendar information at step S402 (step S402, No), the scheduler AP finishes the processing without executing the process procedure at step S403.

An example of a user interface in the pattern file registration unit 13 that performs registration processing on the data string pattern file 14c is explained with reference to FIG. 9. FIG. 9 is an example of the user interface. As shown in FIG. 9, a menu screen relating to a scan function is displayed on the display unit (not shown) in the information processing terminal 10 (see the left part in FIG. 9). When the user selects “detection information setting” from the menu (see (1)), a detection information selection screen is displayed on the display unit (see the middle part in FIG. 9).

When the user selects “date information” and “position information” from the detection information selection screen and pushes a set button at the bottom right on the screen (see (2)), a popup screen including a character string of “setting completed” is displayed on the display unit (see the right part in FIG. 9), and the user is informed that the detection information has been registered.

In FIG. 9, although an example in which the user selects the “date information” and the “position information” has been explained, the number of items to be selected is not limited. An item such as “xx information” shown in FIG. 9 can be selected.

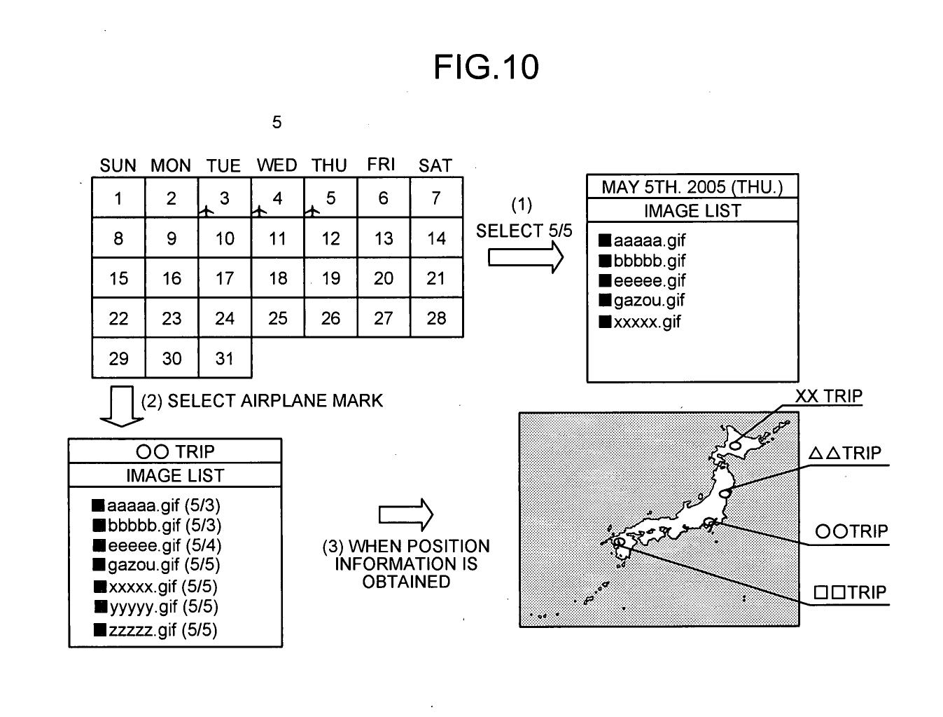

An example in which data coordination is executed by the scheduler AP is explained with reference to FIG. 10. FIG. 10 is an example of data display. As shown in FIG. 10, the scheduler AP displays a calendar on the display unit (not shown). When the user selects May 5th from the date in the calendar (see (1)), a data file associated beforehand with the calendar information is searched for, and an image list including “DATE:” of May 5th is displayed.

In FIG. 10, although an example in which a list of image file names is displayed is explained, a list of thumbnails of the image files can be displayed.

Thus, the coordination destination application 100b can rearrange the data files based on the data coordination information informed by the data coordination information notifying unit 12c. That is, since the coordination source application 100a can receive the information such as date and the position included in the data file stored in the storage unit 14 from the data coordination information notifying unit 12c, the coordination destination application 100b can rearrange and perform grouping of the data files without reading the contents of the data file.

An airplane mark is added to the part of May 3rd to 5th in the calendar displayed on the display unit. This mark is added by the user's operation, and indicates the schedule information that the user is on a trip from May 3rd to 5th. When the user selects this airplane mark (see (2)), an image list corresponding to May 3rd to 5th is displayed together with a pre-registered trip name (oo trip).

When the information relating to “POSI:”, that is, the position information of these data files has been received from the data coordination information notifying unit 12c (see (3)), the trip name can be displayed together with the map information.

According to the embodiment, the data string pattern file is stored in the storage unit separately from the virus pattern file. The virus detection processor extracts data coordination information from a data file based on the data string pattern file. The data coordination information and access information, which indicates where the data file is stored, are notified to the coordination destination application. The coordination destination application performs data coordination of the data file based on the data coordination information and access information. Therefore, data coordination can be performed among various APs at low cost. Moreover, because the data string pattern file and the virus pattern file are separate files, manufacturers of the information processing terminals and the application programs can freely and separately prepare and customaries these files.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data coordination method of coordinating data between a source application program and a destination application program in an information processing terminal, the information processing terminal including a data storage unit configured to store therein data, a virus pattern file describing characteristics of a computer virus, and a data string pattern file describing a detecting data string; and an applications storage unit that stores therein a plurality of application programs each capable of creating data and storing the data in the data storage unit, and a virus detection program configured to detect a virus contained in the data created by any one of the application programs based on the virus pattern file before storing the data in the data storage unit, the application programs including a source application program that creates a specific data and a destination application program that makes use of the specific data, the data coordination method comprising:
executing the virus detection program whereby the virus detection program looks for a data string in the specific data based on the detecting data string in the data string pattern file in the data storage unit and extracts the data string if such a data string is present in the specific data; and
notifying the data string extracted by the virus detection program at the executing and path information that specifies path of the specific data as data coordination information to the destination application program.

2. The data coordination method according to claim 1, further comprising creating and storing the data string pattern file in the storage unit.

3. The data coordination method according to claim 1, wherein the virus pattern file and the data string pattern file being separate files.

4. The data coordination method according to claim 1, wherein the data string pattern file includes pattern information for detecting a data string relating to any one of date information and position information or both included in the data created by any one of the application programs.

5. The data coordination method according to claim 1, wherein the executing includes looking for a data string in the specific data each time the destination application program requests the virus detection program to detect a virus contained in the data.

6. The data coordination method according to claim 1, wherein the executing includes looking for a data string in the specific data each time the destination application program is activated.

7. The data coordination method according to claim 1, wherein the executing includes looking for a data string in the specific data at a timing specified by a user.

8. The data coordination method according to claim 1, wherein the destination application program is a schedule management program that manages schedule by using at least one of calendar information and map information.

9. The data coordination method according to claim 8, wherein the data is e-mail data, and
the schedule management program extracts e-mail data from the data storage unit based on the storage destination information, and handles extracted e-mail data in association with the calendar information based on the date information.

10. The data coordination method according to claim 8, wherein the data is image data, and
the schedule management program extracts image data from the data storage unit based on the storage destination information, and handles extracted image data in association with the calendar information based on the date information.

11. The data coordination method according to claim 8, wherein the data is e-mail data, and
the schedule management program extracts e-mail data from the data storage unit based on the storage destination information, and handles extracted e-mail data in association with the map information.

12. The data coordination method according to claim 8, wherein the data is image data, and
the schedule management program extracts image data from the data storage unit based on the storage destination information, and handles extracted image data in association with the map information.

13. A computer-readable recording medium that stores therein a computer program that implements on a computer a data coordination method of coordinating data between a source application program and a destination application program in an information processing terminal, the information processing terminal including a data storage unit configured to store therein data, a virus pattern file describing characteristics of a computer virus, and a data string pattern file describing a detecting data string; and an applications storage unit that stores therein a plurality of application programs each capable of creating data and storing the data in the data storage unit, and a virus detection program configured to detect a virus contained in the data created by any one of the application programs based on the virus pattern file before storing the data in the data storage unit, the application programs including a source application program that creates a specific data and a destination application program that makes use of the specific data, the computer program causing the computer to execute:
executing the virus detection program whereby the virus detection program looks for a data string in the specific data based on the detecting data string in the data string pattern file in the data storage unit and extracts the data string if such a data string is present in the specific data; and
notifying the data string extracted by the virus detection program at the executing and path information that specifies path of the specific data as data coordination information to the destination application program.

14. An information processing terminal comprising:
a data storage unit configured to store therein data, a virus pattern file describing characteristics of a computer virus, and a data string pattern file describing a detecting data string;
an applications storage unit that stores therein a plurality of application programs each capable of creating data and storing the data in the data storage unit, and a virus detection program configured to detect a virus contained in the data created by any one of the application programs based on the virus pattern file before storing the data in the data storage unit, the application programs including a source application program that creates a specific data and a destination application program that makes use of the specific data;
an executing unit that executes the virus detection program whereby the virus detection program looks for a data string in the specific data based on the detecting data string in the data string pattern file in the data storage unit and extracts the data string if such a data string is present in the specific data; and
a notifying unit that notifies the data string extracted by the virus detection program and path information that specifies path of the specific data as data coordination information to the destination application program.
